(19) United States
(12) Patent Application Publication
(10) Pub. No.: US 2007/0245244 A1
(43) Pub. Date: Oct. 18, 2007

(54) Multimedia playback projection system and method of on-screen display control for multimedia playback projection system

(75) Inventors: Wen-Chang Chien, Hsinchu (TW); Jih-Shun Lo, Hsinchu (TW); Tsair-Pay Yang, Hsinchu (TW)

Correspondence Address: LADAS & PARRY, 5670 WILSHIRE BOULEVARD, SUITE 2100, LOS ANGELES, CA, 90036-5679, US

(73) Assignee: CORETRONIC CORPORATION

(21) Appl. No.: 11/711,454

(22) Filed: Feb. 26, 2007

(30) Foreign Application Priority Data
Apr. 13, 2006 (TW) 095113166

(51) Int. Cl. G06F 3/048

(52) U.S. Cl. 715/730

(57) ABSTRACT

A method of on-screen display control for a multimedia playback projection system includes establishing a command set including a first command subset for adjusting function parameters of a projection unit in a multimedia playback projection system, and a second command subset for adjusting function parameters of a multimedia playback unit; in response to a menu control command, generating an on-screen display control menu including a projection function option and a multimedia playback function option; generating a select control command when selection of one of the options is determined; when the select control command belongs to the first command subset, enabling operation of the system in a projection mode, and adjusting the function parameters of the projection unit; and when the select control command belongs to the second command subset, enabling operation of the system in a multimedia playback mode, and adjusting the function parameters of the multimedia playback unit.

### CROSS-REFERENCE TO RELATED APPLICATION

This application claims priority of Taiwanese Application No. 095113166, filed on Apr. 13, 2006.

### BACKGROUND OF THE INVENTION

1. Field of the Invention

The invention relates to a method of on-screen display (OSD) control, more particularly to a multimedia playback projection system and an on-screen display control method thereof.

2. Description of the Related Art

As shown in FIG. 1, the current way of watching an audiovisual file stored in a storage media 91 is by using a multimedia playback device 92 and a projection device 93 simultaneously. The multimedia playback device 92 retrieves the audiovisual file stored in the storage media 91, and converts the audiovisual file into signals which has a digital format required by the projection device 93. The projection device 93 projects an image corresponding to the signals from the multimedia playback device 92 for viewing by users. Because the projection device 93 is capable of projecting images with large sizes, people have the luxury of big screen viewing as in a movie theater at the comfort of their homes.

However, the multimedia playback device 92 and the projection device 93 have individual remote controllers 921, 931, respectively, for activating on-screen display control menus and for adjusting function parameters thereof, respectively.

In other words, the remote controller 921 is only operable to adjust the function parameters of the multimedia playback device 92, such as play the audiovisual file, pause playback of the audiovisual file, stop the playback of the audiovisual file, etc. On the other hand, the remote controller 931 is only operable to adjust the function parameters of the projection device 93, such as contrast of the image, image source setup, etc.

In this manner, a user needs to confirm which one of the remote controllers 921, 931 is used before performing adjustments of the function parameters, which is time-consuming and inconvenient.

In addition, since font, font size and format of on-screen display control menus vary among different electronic devices, the user needs to get acquainted with individual on-screen display control menus in order to operate them. This is a tedious and troublesome procedure.

### SUMMARY OF THE INVENTION

Therefore, the object of the present invention is to provide an integrated on-screen display control method for a multimedia playback projection system that combines multimedia playback and projection functions.

According to one aspect of the present invention, a method of on-screen display control for a multimedia playback projection system is provided. The multimedia playback projection system includes a projection unit and a multimedia playback unit, and has preset initial values of function parameters of the projection unit and the multimedia playback unit. The method includes the steps of: establishing a command set in the multimedia playback projection system, the command set including a first command subset for adjusting the function parameters of the projection unit, and a second command subset for adjusting the function parameters of the multimedia playback unit; in response to a menu control command, generating an on-screen display control menu including a projection function option and a multimedia playback function option; generating a select control command when selection of one of the options is determined; when the select control command belongs to the first command subset, enabling operation of the multimedia playback projection system in a projection mode, and adjusting the function parameters of the projection unit according to the select control command; and when the select control command belongs to the second command subset, enabling operation of the multimedia playback projection system in a multimedia playback mode, and adjusting the function parameters of the multimedia playback unit according to the select control command.

Another object of the present invention is to provide a multimedia playback projection system that combines multimedia playback and projection functions, that supports on-screen display control, that requires only one remote controller for user control, and that permits adjustment of function parameters of the multimedia playback projection system through a single integrated on-screen display menu.

According to another aspect of the present invention, a multimedia playback projection system is provided and includes a central processing unit, a multimedia playback unit, a projection unit, a control interface, an on-screen display module, and a memory.

The central processing unit is used for coordinating operations among the various units in the multimedia playback projection system.

The multimedia playback unit is coupled to the central processing unit, and includes a multimedia controller and a storage media. The multimedia controller captures a multimedia signal from the storage media, decodes the multimedia signal so as to obtain an image signal, and outputs the image signal to the central processing unit as an image signal source.

The projection unit is coupled to the central processing unit, receives the image signal source from the central processing unit, and converts the image signal source into an image light beam for projecting an image.

The control interface is coupled to the central processing unit for generating a control command to the central processing unit. The control command is one of a menu control command and a select control command.

The on-screen display module is coupled to the central processing unit. The on-screen display module outputs an on-screen display control menu which includes a projection function option and a multimedia playback function option so as to enable display of the on-screen display control menu on the image by the projection unit in response to the menu control command from the central processing unit.

The memory is coupled to the central processing unit, and has preset initial values of function parameters of the projection unit and the multimedia playback unit stored therein. The memory further has a built-in command set. The command set includes a first command subset for adjusting the function parameters of the projection unit, and a second command subset for adjusting the function parameters of the multimedia playback unit.

When the central processing unit determines that the select control command received from the control interface belongs to the first command subset, the central processing unit enables operation of the multimedia playback projection system in a projection mode and adjusts the function parameters of the projection unit according to the select control command received from the control interface such that the projection unit operates according to the adjusted function parameters thereof. When the central processing unit determines that the select control command received from the control interface belongs to the second command subset, the central processing unit enables operation of the multimedia playback projection system in a multimedia playback mode and adjusts the function parameters of the multimedia playback unit according to the select control command received from the control interface such that the multimedia playback unit operates according to the adjusted function parameters thereof.

Yet another object of the present invention is to provide a switching type on-screen display control method for a multimedia playback projection system that combines multimedia playback and projection functions.

According to yet another aspect of the present invention, a method of on-screen display control for a multimedia playback projection system is provided. The multimedia playback projection system includes a projection unit and a multimedia playback unit, and has preset initial values of function parameters of the projection unit and the multimedia playback unit. The method includes the steps of: establishing menu control commands for respectively generating a projection function setting menu and a multimedia playback function setting menu, a first command subset for adjusting the function parameters of the projection unit, and a second command subset for adjusting the function parameters of the multimedia playback unit in the multimedia playback projection system; generating the projection function setting menu; closing the projection function setting menu, and generating the multimedia playback function setting menu when receipt of the menu control command for outputting the multimedia playback function setting menu is determined; when the projection function setting menu is displayed, adjusting the function parameters of the projection unit according to a select control command when the select control command is determined to belong to the first command subset; and when the multimedia playback function setting menu is displayed, adjusting the function parameters of the multimedia playback unit according to a select control command when the select control command is determined to belong to the second command subset.

Still another object of the present invention is to provide a multimedia playback projection system that combines multimedia playback and projection functions, that supports on-screen display control, that requires only one remote controller for user control, and that permits adjustment of function parameters of the multimedia playback projection system through switching-type on-screen display menus.

According to still another aspect of the present invention, a multimedia playback projection system is provided and includes a central processing unit, a control interface, a projection unit, a multimedia playback unit, and a memory.

The control interface is coupled to the central processing unit for generating a control command to the central processing unit. The control command is one of a menu control command and a select control command.

The memory is coupled to the central processing unit, and is established with menu control commands for respectively generating a projection function setting menu and a multimedia playback function setting menu, a first command subset for adjusting function parameters of the projection unit, and a second command subset for adjusting function parameters of the multimedia playback unit.

The multimedia playback unit is coupled to the central processing unit, and includes a multimedia controller, a storage media, and an on-screen display module. The multimedia controller captures a multimedia signal from the storage media, decodes the multimedia signal so as to obtain an image signal, and outputs the image signal to the central processing unit as an image signal source. The on-screen display module of the multimedia playback unit generates the multimedia playback function setting menu in response to the menu control command for outputting the multimedia playback function setting menu from the central processing unit, and enables an image projected by the projection unit to display the multimedia playback function setting menu for adjusting the function parameters of the multimedia playback unit.

The projection unit is coupled to the central processing unit, and includes an on-screen display module for generating the projection function setting menu in response to the menu control command for outputting the projection function setting menu from the central processing unit. The projection unit receives the image signal source from the central processing unit and converts the image signal source into an image light beam for projecting the image. The on-screen display module of the projection unit enables the image projected by the projection unit to display the projection function setting menu for adjusting the function parameters of the projection unit.

Other objectives, features and advantages of the present invention will be further understood from the further technology features disclosed by the present invention wherein there are shown and described preferred embodiments of this invention, simply by way of illustration of modes best suited to carry out the invention.

### BRIEF DESCRIPTION OF THE DRAWINGS

FIG. 1 is a block diagram, illustrating a multimedia playback device and a projection device with their respective remote controllers in the prior art;

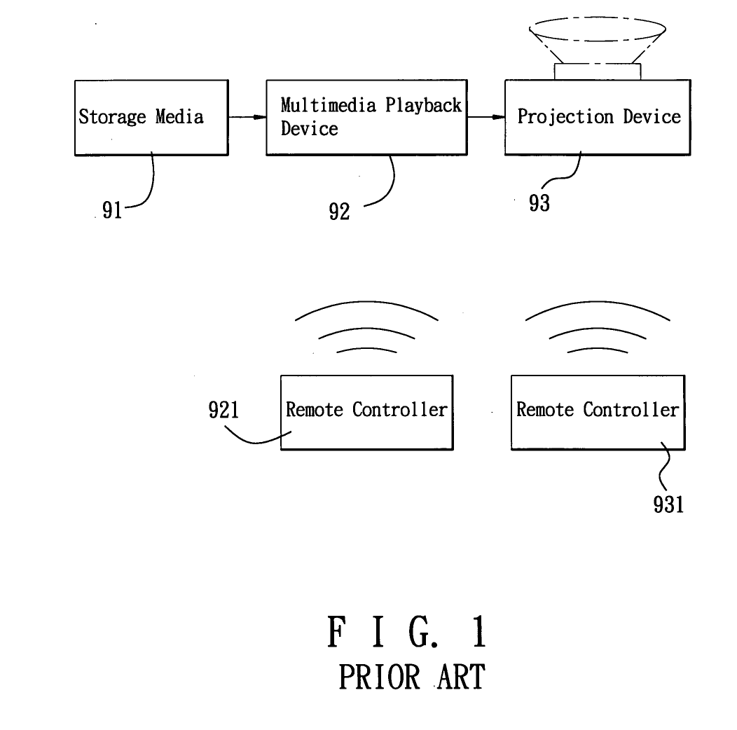

FIG. 2 is a system block diagram, illustrating a first preferred embodiment of a multimedia playback projection system according to the present invention;

FIG. 3 is a schematic diagram of an exemplary on-screen display control menu according to the first preferred embodiment;

FIG. 4 is a flow chart, illustrating a method of on-screen display control for the multimedia playback projection system according to the first preferred embodiment;

FIG. 5 is a system block diagram, illustrating a second preferred embodiment of a multimedia playback projection system according to the present invention;

FIG. 6 is a schematic diagram of exemplary on-screen display control menus according to the second preferred embodiment; and

FIG. 7 is a flow chart, illustrating a method of an on-screen display control for the multimedia playback projection system according to the second preferred embodiment.

### DETAILED DESCRIPTION OF THE PREFERRED EMBODIMENTS

Before the present invention is described in greater detail, it should be noted herein that like elements are denoted by the same reference numerals throughout the disclosure.

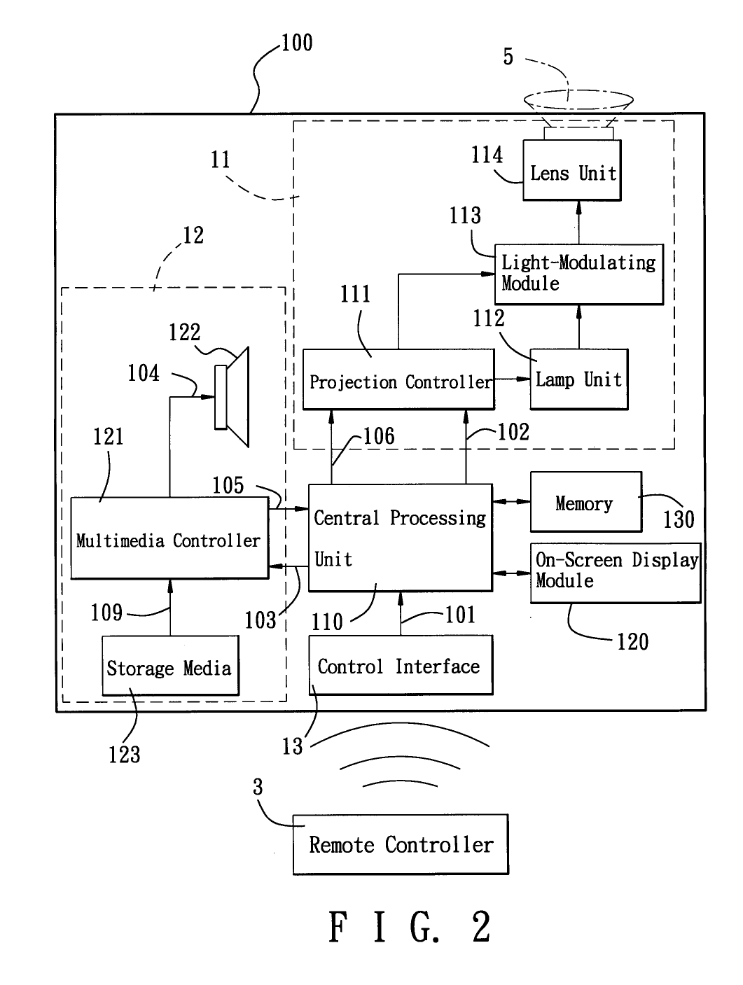

As shown in FIG. 2, a first preferred embodiment of a multimedia playback projection system 100 according to the present invention includes a projection unit 11, a multimedia playback unit 12, a control interface 13, a central processing unit 110, an on-screen display module 120, a memory 130, and a remote controller 3.

The multimedia playback unit 12 includes a multimedia controller 121 coupled to the central processing unit 110, a speaker 122 and a storage media 123 coupled to the multimedia controller 121. The storage media 123 contains audiovisual data therein, and is in the form of a digital versatile disc (DVD), a video compact disc (VCD), or a source of digital television. The multimedia controller 121 is operable to access the storage media 123 and captures a multimedia signal 109 from the storage media. The multimedia controller 121 is further operable to decode the multimedia signal 109 so as to obtain an audio signal 104 and an image signal 105. In this embodiment, the multimedia controller 121 outputs the audio signal 104 to the speaker 122 for reproduction thereby, and the image signal 105 to the central processing unit 110. The central processing unit 110 provides the image signal 105 to the projection unit 11 as an image signal source 106 for the projection unit 110.

The projection unit 11 includes a projection controller 111, a lamp unit 112, a light-modulating module 113, and a lens unit 114. The projection controller 111 is controlled by the central processing unit 110. The projection unit 11 receives the image signal source 106 from the central processing unit 110, and converts the image signal source 106 for projecting an image 5. The lamp unit 112 is coupled to the projection controller 111 and is capable of providing a light source. The light-modulating module 113 is coupled to the projection controller 111 for converting the image signal source 106 into an image light beam. For instance, the light-modulating module 113 includes a color wheel, an integrator and a light valve. The lens unit 114 is disposed on an optical path of the image light beam for projecting the image 5. For example, the lens unit 114 is a projection lens.

The central processing unit 110 coordinates the operations among the various units in the multimedia playback projection system 100. The central processing unit 110 receives a control command 101 from the control interface 13 for controlling the on-screen display module 120, and for retrieving information from the memory 130. The control command 101 is one of a menu control command and a select control command.

In this embodiment, the control interface 13 is a wireless transmission interface, and the remote controller 3 is operable to send out a wireless control signal for the control interface 13. In particular, the control interface 13 is an infrared light control interface that includes an infrared receiver (not shown) and an infrared decoder (not shown). The control interface 13 receives a wireless (infrared) control signal sent out by the remote controller 3, and in response, generates the corresponding control command 101 to the central processing unit 110. In other embodiments, the control interface 13 is also a set of keys provided on the system, or is in a form implementing other control methods, details of which are omitted herein for the sake of brevity.

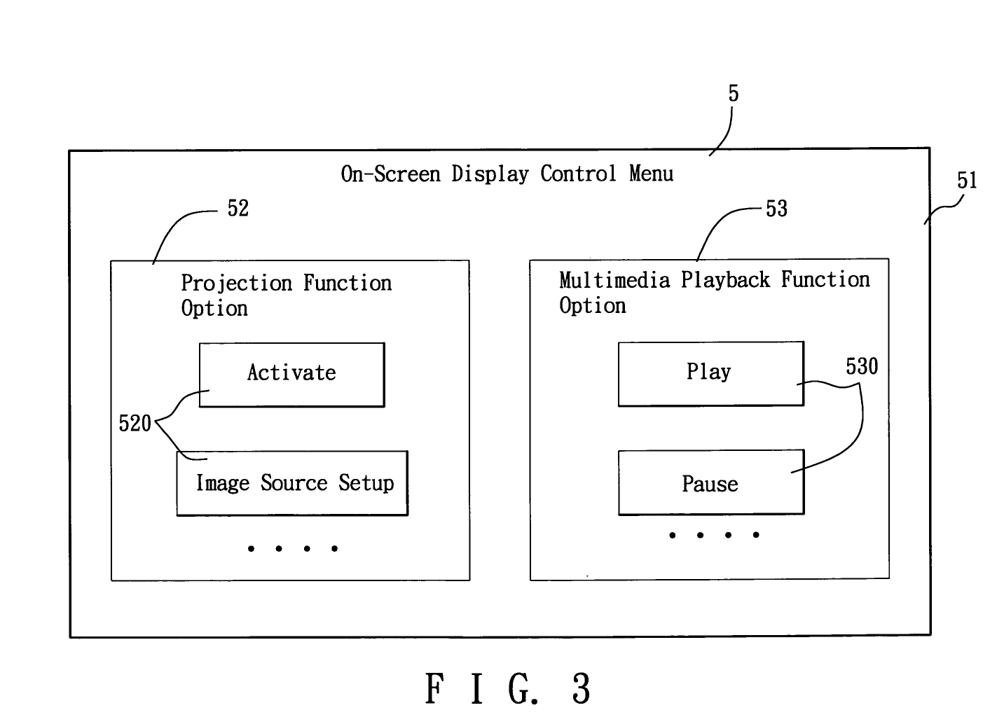

As shown in FIG. 2 and FIG. 3, the on-screen display module 120 is coupled to the central processing unit 110. When the central processing unit 110 receives the menu control command from the control interface 13, the central processing unit 110 commands the on-screen display module 120 to generate an on-screen display control menu 51, which includes a projection function option 52 and a multimedia playback function option 53, so as to enable display of the on-screen control menu 51 on the image 5 by the projection unit 11 in response to the menu control command from the central processing unit 110.

During user operation, the remote controller 3 is used to select one of the options in the on-screen display control menu 51. In practice, the remote controller 3 sends out the wireless control signal to the control interface 13, which responds by generating the corresponding control command 101 to the central processing unit 110 to inform the central processing unit 110 of which option is selected and corresponding item 520, 530 is to be adjusted.

The memory 130 is coupled to the central processing unit 110, and has preset initial values of the function parameters of the projection unit 11 and the multimedia playback unit 12 stored therein, such as contrast of image projection, volume, etc. During operation, when any one of the options in the on-screen display control menu 51 is selected, the central processing unit 110 updates the corresponding function parameters of the projection unit 11 and the multimedia playback unit 12 preset in the multimedia playback projection system 100 to the values of the adjusted function parameters. Subsequently, the central processing unit 110 commands a corresponding one of the projection unit 11 and the multimedia playback unit 12 to operate according to the adjusted function parameters.

The memory 130 according to the present invention further has a built-in command set. The command set includes a first command subset for adjusting the function parameters of the projection unit 11, such as contrast of image projection, image source setup, etc., and a second command subset for adjusting the function parameters of the multimedia playback unit 12, such as switching operation mode of the multimedia playback unit 12 among play mode (play the audiovisual file), pause mode (pause playback of the audiovisual file), stop mode (stop the playback of the audiovisual file), etc.

Taking FIG. 3 as an example, and with further reference to FIG. 2, when a user selects the item 520 of the projection function option 52 via the remote controller 3, the remote controller 3 sends out a select signal to the control interface 13, and the control interface 13 sends out the select control command corresponding to the select signal and belonging to the first command subset to command the central processing unit 110 to take appropriate action. If the user selects the item 530 of the multimedia playback option 53, then the control interface 13 sends out the select control command belonging to the second command subset to command the central processing unit 110 to take appropriate action.

The actions taken when the projection function option 52 is selected are that, when the central processing unit 110 determines that the select control command belongs to the first command subset, then the central processing unit 110 enables operation of the multimedia playback projection system 100 in a projection mode, and adjusts the function parameters of the projection unit 11 stored in the memory 130 according to the select control command received from the control interface 13. Subsequently, the central processing unit 110 transmits an adjustment command 102 to the projection controller 111 of the projection unit 11 such that the projection unit 11 operates according to the adjusted function parameters. For example, the contrast of the image 5 is adjusted as a result.

The actions taken when the multimedia playback function option 53 is selected are that, when the central processing unit 110 determines that the select control command belongs to the second command subset, then the central processing unit 110 enables operation of the multimedia playback projection system 100 in a multimedia playback mode, and adjusts the function parameters of the multimedia playback unit 12 stored in the memory 130 according to the select control command received from the control interface 13. Subsequently, the central processing unit 110 transmits an adjustment command 103 to the multimedia playback controller 121 of the multimedia playback unit 12 such that the multimedia playback unit 12 operates according to the adjusted function parameters. For example, the operation mode for the multimedia signal 109 is switched from the play mode to the pause mode as a result.

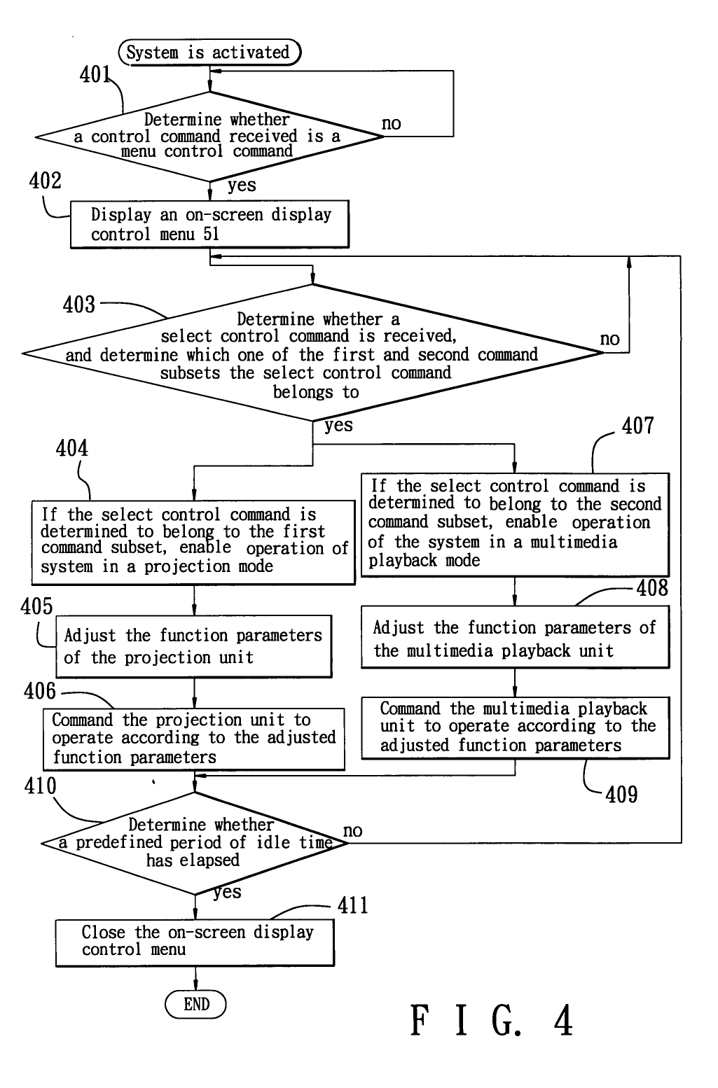

The on-screen display control method for the multimedia playback projection system 100 according to the first preferred embodiment is described hereinafter with reference to FIG. 2 and FIG. 4. It should be noted herein that the method starts with establishing a command set in the multimedia playback projection system 100. The command set includes a first command subset for adjusting the function parameters of the projection unit 11, and a second command subset for adjusting the function parameters of the multimedia playback unit 12.

While the multimedia playback projection system 100 is activated, upon receipt of a control command 101 from the control interface 13, the central processing unit 110 first determines whether the control command 101 is a menu control command (step 401). If yes, in response to the menu control command, an on-screen display control menu 51 (shown in FIG. 3) that includes a projection function option 52 (shown in FIG. 3) and a multimedia playback function option 53 (shown in FIG. 3) is generated in the manner described hereinabove (step 402). Next, the central processing unit 110 determines whether a select control command is received (step 403). If yes, the central processing unit 110 then determines which one of the first and second command subsets the select control command belongs to.

If the select control command is determined to belong to the first command subset, then the central processing unit 110 enables operation of the multimedia playback projection system 100 in a projection mode (step 404), and adjusts the function parameters of the projection unit 11 stored in the memory 130 according to the select control command (step 405). Then, the preset initial values of the function parameters of the projection unit 11 are updated to the values of the adjusted function parameters stored in the memory 130, and the central processing unit 110 commands the projection unit 11 to operate according to the adjusted function parameters (step 406).

If the select control command is determined to belong to the second command subset, then the central processing unit 110 enables operation of the multimedia playback projection system 100 in a multimedia playback mode (step 407), and adjusts the function parameters of the multimedia playback unit 12 stored in the memory 130 according to the select control command (step 408). Then, the preset initial values of the function parameters of the multimedia playback unit 12 are updated to the values of the adjusted function parameters stored in the memory 130, and the central processing unit 110 commands the multimedia playback unit 12 to operate according to the adjusted function parameters (step 409).

Subsequently, the central processing unit 110 determines whether a predefined period of idle time has elapsed (step 410). If no, the flow goes back to determining whether a select control command is received (step 403). If yes, the on-screen display control menu 51 is closed (step 411).

In sum, the present invention integrates the on-screen display control menus of both the projection unit 11 and the multimedia playback unit 12 into a single on-screen display control menu 51 according to the first preferred embodiment. A remote controller 3 is used to select one of the options in the on-screen display control menu 51 so as to generate a control command 101, and the control command 101 is one of a menu control command and a select control command. A central processing unit 110 refers to a built-in command set stored in a memory 130 to determine the type of the control command 101. The central processing unit 110 then commands the projection unit 11 or the multimedia playback unit 12 to perform adjustments according to the control command. This facilitates user control over the function parameters of the projection unit 11 and the multimedia playback unit 12, which is more convenient as compared to the prior art.

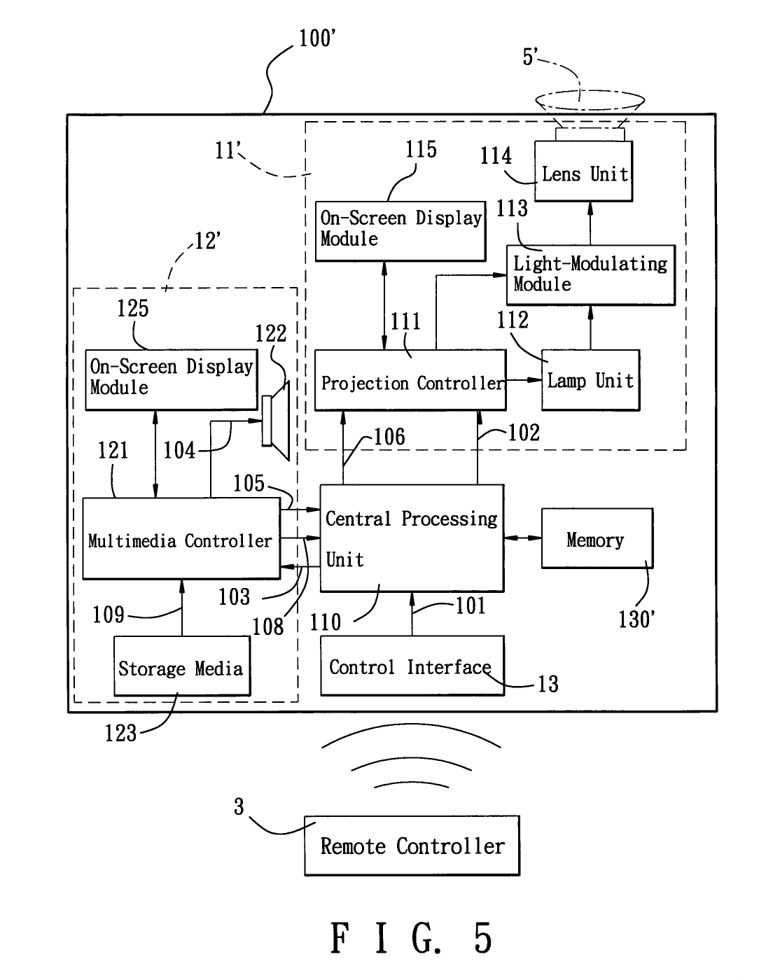

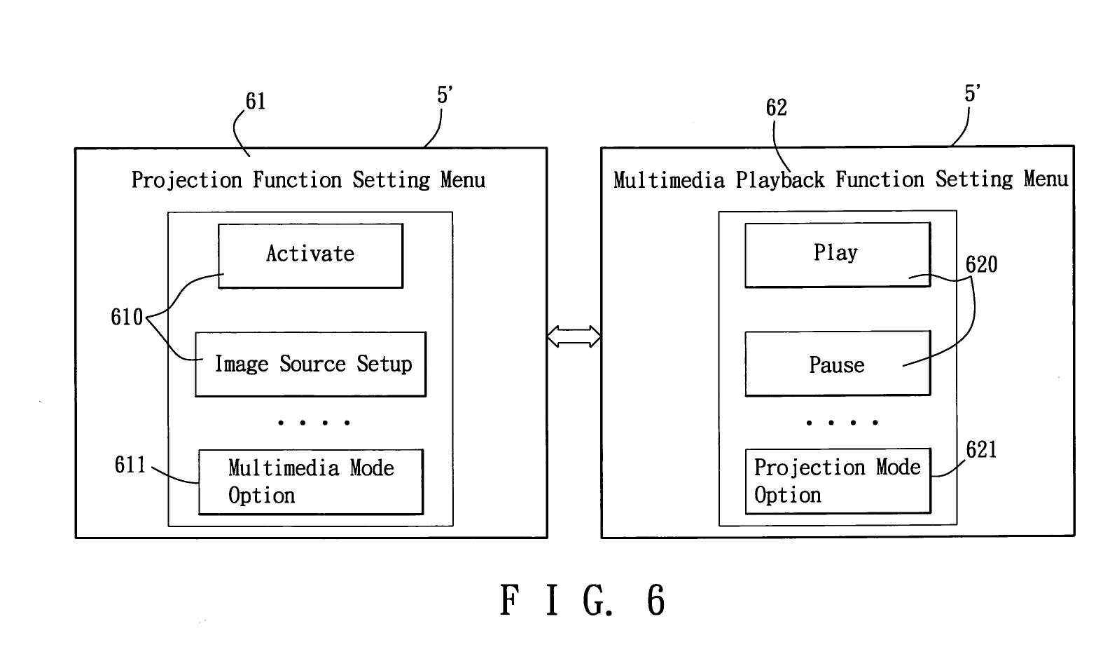

As shown in FIG. 5 and FIG. 6, the second preferred embodiment of a multimedia playback projection system 100′ according to the present invention is similar to the first preferred embodiment. Details of similar components are omitted herein for the sake of brevity.

The main difference between the first and second preferred embodiments is that the projection unit 11′ and the multimedia playback unit 12′ according to the second preferred embodiment have separate on-screen display modules 115, 125, respectively. In addition, the image 5′ projected by the projection unit 11′ in the multimedia playback projection system 100′ displays a projection function setting menu 61 (refer to FIG. 6) and a multimedia playback function setting menu 62 (refer to FIG. 6) separately and interchangeably.

The on-screen display module 115 of the projection unit 11′ is coupled to the projection controller 111. The on-screen display module 115 of the projection unit 11′ is capable of generating the projection function setting menu 61 in response to the menu control command for outputting the projection function setting menu 61 from the central processing unit 110. Besides, the on-screen display module 115 of the projection unit 11′ receives the adjustment command 102 from the central processing unit 110 via the projection controller 111, and enables the image 5′ projected by the projection unit 11′ to display the projection function setting menu 61 for adjusting the function parameters of the projection unit 11′. The on-screen display module 125 of the multimedia playback unit 12′ is coupled to the multimedia controller 121. The on-screen display module 125 of the multimedia playback unit 12′ is capable of generating the multimedia playback function setting menu 62 in response to the menu control command for outputting the multimedia playback function setting menu 62 from the central processing unit 110. In addition, the on-screen display module 125 of the multimedia playback unit 12′ receives the adjustment command 103 from the central processing unit 110 via the multimedia playback controller 121, and enables the image 5′ projected by the projection unit 11′ to display the multimedia playback function setting menu 62 for adjusting the function parameters of the multimedia playback unit 12′.

In this embodiment, the memory 130 not only has the first command subset for adjusting the function parameters of the projection unit 11′, and the second command subset for adjusting the function parameters of the multimedia playback unit 12′, but also has menu control commands for respectively generating the projection function setting menu 61 and the multimedia playback function setting menu 62 so as to permit switching between the projection and multimedia playback function setting menus 61, 62.

Aside from a plurality of function items 610 for adjusting the function parameters of the projection unit 11′, the projection function setting menu 61 generated by the on-screen display module 115 of the projection unit 11′ further includes a multimedia mode option 611 for switching to the multimedia playback function setting menu 62. Likewise, aside from a plurality of function items 620 for adjusting the function parameters of the multimedia playback unit 12′, the multimedia playback function setting menu 62 generated by the on-screen display module 125 of the multimedia playback unit 12′ further includes a projection mode option 621 for switching to the projection function setting menu 61.

In this embodiment, the central processing unit 110 is responsive to a control command 101 received from the control interface 13 to control one of the projection unit 11′ and the multimedia playback unit 12′ so that the on-screen display module 115, 125 of the one of the projection unit 11′ and the multimedia playback unit 12′ generates the corresponding one of the projection and multimedia playback function setting menus 61, 62.

For example, when a user operates the remote controller 3 to activate the projection function setting menu 61, if the multimedia mode option 611 in the projection function setting menu 61 is selected, then the image 5′ switches to displaying the multimedia playback function setting menu 62, at which time, the function items 620 in the multimedia playback function setting menu 62 is selected to adjust various function parameters associated with the multimedia playback unit 12′. On the other hand, while the multimedia playback function setting menu 62 is displayed, when it is desired to switch to the projection function setting menu 61, the projection mode option 621 in the multimedia playback function setting menu 62 is selected. At this time, adjustments of the function parameters of the projection unit 11′ are made by selecting the function items 610 in the projection function setting menu 61.

When the central processing unit 110 receives the menu control command from the control interface 13 for outputting the multimedia playback function setting menu 62 in response to selection of the multimedia mode option 611 in the projection function setting menu 61, the central processing unit 110 sends an adjustment command 103 to the multimedia playback controller 121, which responds by sending a deactivate command 108 to inform the central processing unit 110 to close the projection function setting menu 61 generated by the on-screen display module 115 of the projection unit 11′. The multimedia playback function setting menu 62 is displayed on the image 5′. On the other hand, when the central processing unit 110 receives the menu control command from the control interface 13 for outputting the projection function setting menu 61 in response to selection of the projection mode option 611 in the projection function setting menu 61, the central processing unit 110 sends an adjustment command 102 to the projection controller 121. The multimedia playback function setting menu 62 is closed, and the projection function setting menu 61 is displayed on the image 5′.

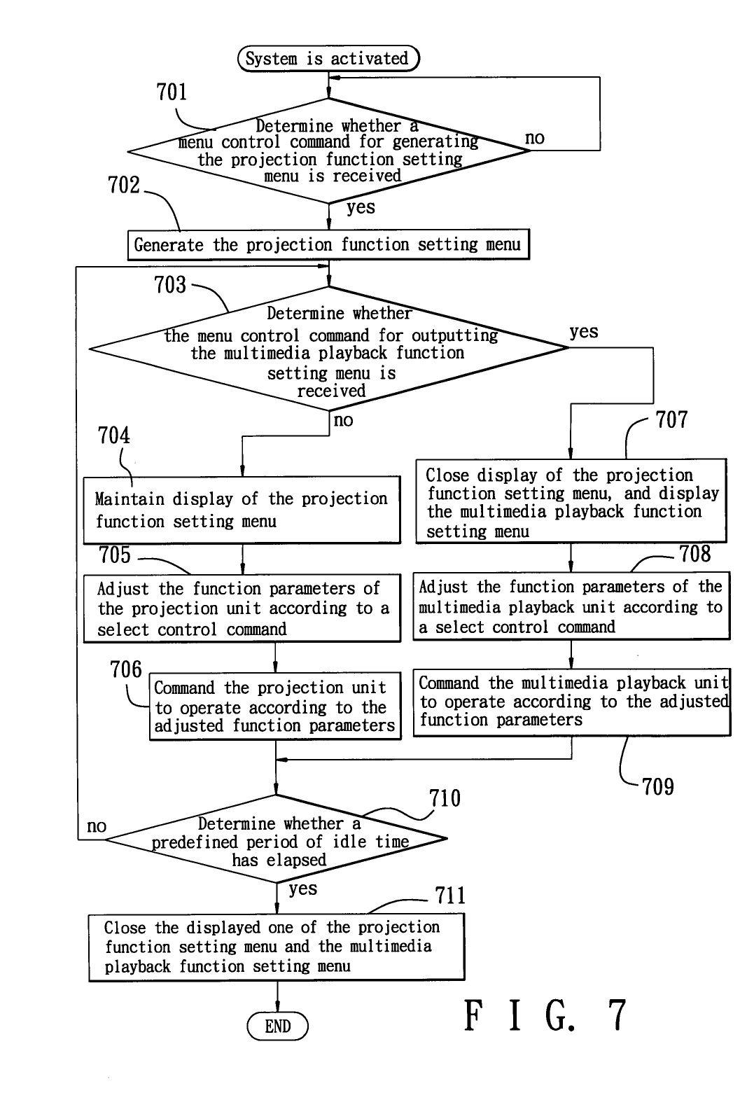

The on-screen display control method according to the second preferred embodiment is described hereinafter with reference to FIG. 5 and FIG. 7. It should be noted herein that the method starts with establishing menu control commands for respectively generating a projection function setting menu 61 and a multimedia playback function setting menu 62, a first command subset for adjusting the function parameters of the projection unit 11′, and a second command subset for adjusting the function parameters of the multimedia playback unit 12′ in the multimedia playback projection system 100′.

While the multimedia playback projection system 100′ is activated, upon receipt of a control command 101 from the control interface 13, the central processing unit 110 first determines whether the control command 101 is a menu control command for generating the projection function setting menu 61 (shown in FIG. 6) (step 701). If yes, in response to the menu control command, the projection function setting menu 61 (shown in FIG. 6) that includes a set of function items 610 (shown in FIG. 6) and a multimedia mode option 611 (shown in FIG. 6) is generated in the manner described hereinabove (step 702).

Next, the central processing unit 110 determines whether the menu control command for outputting the multimedia playback function setting menu 62 (shown in FIG. 6) is received (step 703). If not, in which case one of the function items 610, not the multimedia mode option 611, in the projection function setting menu 61 is selected, display of the projection function setting menu 61 is maintained (step 704). Then, the central processing unit 110 determines whether a select command 101 is received. If yes, When the central processing unit 110 determines that the select control command belongs to the first command subset, the function parameters of the projection unit 11′ stored in the memory 130 is adjusted according to the select control command (step 705). Subsequently, the preset initial values of the function parameters of the projection unit 11′ are updated to the values of the adjusted function parameters stored in the memory 130 so as to command the projection unit 11′ to operate according to the adjusted function parameters (step 706).

If the determination result in step 703 is yes, in which case the multimedia mode option 611 in the projection function setting menu 61 is selected, display of the projection function setting menu 61 is closed, and the multimedia playback function setting menu 62 is displayed on the image 5′ (step 707). When the central processing unit 110 determines that the select control command belongs to the second command subset, the function parameters of the multimedia playback unit 12′ stored in the memory 130 are adjusted according to the select control command (step 708). Subsequently, the preset initial values of the function parameters of the multimedia playback unit 12′ are updated to the values of the adjusted function parameters stored in the memory 130 so as to command the multimedia playback unit 12′ to operate according to the adjusted function parameters (step 709).

Subsequently, the central processing unit 110 determines whether a predefined period of idle time has elapsed (step 710). If not, the flow goes back to determining whether a control command 101 is received (step 701). If yes, the displayed one of the projection function setting menu 61 and the multimedia playback function setting menu 62 is closed (step 711).

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A method of on-screen display control for a multimedia playback projection system including a projection unit and a multimedia playback unit, and having preset initial values of function parameters of the projection unit and the multimedia playback unit, the method comprising the steps of:
establishing a command set in the multimedia playback projection system, the command set including a first command subset for adjusting the function parameters of the projection unit, and a second command subset for adjusting the function parameters of the multimedia playback unit;
in response to a menu control command, generating an on-screen display control menu including a projection function option and a multimedia playback function option;
generating a select control command when selection of one of the options is determined;
when the select control command belongs to the first command subset, enabling operation of the multimedia playback projection system in a projection mode, and adjusting the function parameters of the projection unit according to the select control command; and
when the select control command belongs to the second command subset, enabling operation of the multimedia playback projection system in a multimedia playback mode, and adjusting the function parameters of the multimedia playback unit according to the select control command.

2. The method as claimed in claim 1, further comprising the step of:
updating the preset initial values of the function parameters of the projection unit and the multimedia playback unit preset in the multimedia playback projection system to values of the adjusted function parameters.

3. The method as claimed in claim 2, further comprising the step of:
closing the on-screen display control menu upon determining elapse of a predefined period of idle time.

4. A multimedia playback projection system, comprising:
a central processing unit;
a multimedia playback unit coupled to the central processing unit, and including a multimedia controller and a storage media, the multimedia controller capturing a multimedia signal from the storage media, decoding the multimedia signal so as to obtain an image signal, and outputting the image signal to the central processing unit as an image signal source;
a projection unit coupled to the central processing unit, receiving the image signal source from the central processing unit, and converting the image signal source into an image light beam for projecting an image;
a control interface coupled to the central processing unit for generating a control command to the central processing unit, the control command being one of a menu control command and a select control command;
an on-screen display module coupled to the central processing unit, the on-screen display module outputting an on-screen display control menu which includes a projection function option and a multimedia playback function option so as to enable display of the on-screen display control menu on the image by the projection unit in response to the menu control command from the central processing unit; and
a memory coupled to the central processing unit, and having preset initial values of function parameters of the projection unit and the multimedia playback unit stored therein, the memory further having a built-in command set, the command set including a first command subset for adjusting the function parameters of the projection unit, and a second command subset for adjusting the function parameters of the multimedia playback unit;
wherein when the central processing unit determines that the select control command received from the control interface belongs to the first command subset, the central processing unit enables operation of the multimedia playback projection system in a projection mode and adjusts the function parameters of the projection unit according to the select control command received from the control interface, the projection unit operating according to the adjusted function parameters thereof, and when the central processing unit determines that the select control command received from the control interface belongs to the second command subset, the central processing unit enables operation of the multimedia playback projection system in a multimedia playback mode and adjusts the function parameters of the multimedia playback unit according to the select control command received from the control interface, the multimedia playback unit operating according to the adjusted function parameters thereof.

5. The multimedia playback projection system as claimed in claim 4, wherein the control interface is a wireless transmission interface, and the multimedia playback projection system further comprises a remote controller operable to send out a wireless control signal for driving the control interface, which provides the control command corresponding to the wireless control signal to the central processing unit.

6. A method of on-screen display control for a multimedia playback projection system including a projection unit and a multimedia playback unit, and having preset initial values of function parameters of the projection unit and the multimedia playback unit, the method comprising the steps of:
establishing menu control commands for respectively generating a projection function setting menu and a multimedia playback function setting menu, a first command subset for adjusting the function parameters of the projection unit, and a second command subset for adjusting the function parameters of the multimedia playback unit in the multimedia playback projection system;
generating the projection function setting menu;
closing the projection function setting menu, and generating the multimedia playback function setting menu when receipt of the menu control command for outputting the multimedia playback function setting menu is determined;
when the projection function setting menu is displayed, adjusting the function parameters of the projection unit according to a select control command when the select control command is determined to belong to the first command subset; and
when the multimedia playback function setting menu is displayed, adjusting the function parameters of the multimedia playback unit according to a select control command when the select control command is determined to belong to the second command subset.

7. The method as claimed in claim 6, further comprising the step of:
updating the preset initial values of the function parameters of the projection unit and the multimedia playback unit of the multimedia playback projection system to the values of the adjusted function parameters.

8. The method as claimed in claim 7, further comprising the step of:
closing the displayed one of the projection function setting menu and the multimedia playback function setting menu upon determining elapse of a predefined period of idle time.

9. A multimedia playback projection system, comprising:
a central processing unit;
a control interface coupled to the central processing unit for generating a control command to the central processing unit, the control command being one of a menu control command and a select control command;
a projection unit;
a multimedia playback unit; and
a memory coupled to the central processing unit, and established with menu control commands for respectively generating a projection function setting menu and a multimedia playback function setting menu, a first command subset for adjusting function parameters of the projection unit, and a second command subset for adjusting function parameters of the multimedia playback unit;
the multimedia playback unit being coupled to the central processing unit, and including a multimedia controller, a storage media, and an on-screen display module, the multimedia controller capturing a multimedia signal from the storage media, decoding the multimedia signal so as to obtain an image signal, and outputting the image signal to the central processing unit as an image signal source, wherein the on-screen display module of the multimedia playback unit generates the multimedia playback function setting menu in response to the menu control command for outputting the multimedia playback function setting menu from the central processing unit, and enables an image projected by the projection unit to display the multimedia playback function setting menu for adjusting the function parameters of the multimedia playback unit;
the projection unit being coupled to the central processing unit, and including an on-screen display module for generating the projection function setting menu in response to the menu control command for outputting the projection function setting menu from the central processing unit, the projection unit receiving the image signal source from the central processing unit and converting the image signal source into an image light beam for projecting the image, the on-screen display module of the projection unit enabling the image projected by the projection unit to display the projection function setting menu for adjusting the function parameters of the projection unit.

10. The multimedia playback projection system as claimed in claim 9, wherein the control interface is a wireless transmission interface, and the multimedia playback projection system further comprises a remote controller operable to send out a wireless control signal for driving the control interface, which provides the control command corresponding to the wireless control signal to the central processing unit.

11. The multimedia playback projection system as claimed in claim 9, wherein the projection function setting menu generated by the on-screen display module of the projection unit includes a multimedia mode option, and the multimedia playback function setting menu generated by the on-screen display module of the multimedia playback unit includes a projection mode option,
when the central processing unit receives the menu control command from the control interface for outputting the multimedia playback function setting menu in response to selection of the multimedia mode option in the projection function setting menu, the projection function setting menu is closed, and the multimedia playback function setting menu is displayed on the image, and
when the central processing unit receives the menu control command from the control interface for outputting the projection function setting menu in response to selection of the projection mode option in the multimedia playback function setting menu, the multimedia playback function setting menu is closed, and the projection function setting menu is displayed on the image.
